(19) United States
(12) Patent Application Publication
(10) Pub. No.: US 2015/0347976 A1
(43) Pub. Date: Dec. 3, 2015

(54) Talent Management

(71) Applicant: PeopleFluent, Inc., Waltham, MA (US)

(72) Inventors: Mark Lawrence Munzer, Westwood, MA (US); Charles S. Jones, Waltham, MA (US)

(21) Appl. No.: 14/722,462

(22) Filed: May 27, 2015

Related U.S. Application Data
(60) Provisional application No. 62/005,462, filed on May 30, 2014.

(51) Int. Cl. G06Q 10/10; G06F 17/21; G06F 3/0484

(52) U.S. Cl. CPC G06Q 10/1053; G06F 3/0484; G06F 17/212

(57) ABSTRACT

Among other things, we describe presenting, through a user interface, a document that contains information about an employment relationship of a person with an entity, while the document is being presented through the user interface, receiving from a presenter video information capturing a presentation about the information contained in the document, and providing a coordinated presentation of the document and the presentation to the presenter or to a party other than the presenter, through a user interface.

### BACKGROUND

This description relates to talent management.

A Human Resources department may manage a company's employees. For example, a Human Resources department may be in charge of determining employees' salaries, bonuses, and raises and hiring new employees.

### SUMMARY

The electronic communicating that we describe here may encompass one or more of the following (and other) aspects, features, and implementations, and combinations of them.

In general, in an aspect, a method includes presenting, through a user interface, a document that contains information about an employment relationship of a person with an entity, while the document is being presented through the user interface, receiving from a presenter video information capturing a presentation about the information contained in the document, and providing a coordinated presentation of the document and the presentation to the presenter or to a party other than the presenter, through a user interface.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of this aspect or another aspect may include one or more of the following features. The method may include receiving the document from a user device controlled by the presenter. The document may include information about a job position. The presenter may be a talent manager and the presentation may include the talent manager describing a performance of the person while executing duties for the entity.

In some implementations, the method includes determining, for each portion of the presentation, which corresponding portion of the document is displayed in the user interface when the respective portion of the presentation is captured, and providing the corresponding portions of the document concurrently with the respective portions of the presentation. The document may include a resume, a cover letter, a self-assessment, a goal, an employee evaluation, a business plan, a question for a job applicant, or any combination of two or more of them. The presenter may be a job applicant for a position administered by the party other than the presenter and the method may include presenting, to the job applicant prior to presenting the document, video information of the party other than the presenter describing the position. The presenter may be a job applicant for a position at an entity with which a potential co-worker is associated and the method may include presenting, to the job applicant prior to presenting the document, video information of the potential co-worker describing the position, the entity with which the potential co-worker is associated, or an area in which the position is based.

In some implementations, the method includes receiving a comment about the information about the document or the presentation while providing the coordinated presentation of the document and the presentation, and associating the comment with the document or the presentation. The method may include presenting, through a user interface to another party other than the presenter, the document and the presentation concurrently with the comment. The presenting to the presenter or the party other than the presenter and the other party other than the presenter may occur at substantially the same time. The method may include displaying, through a user interface to another party other than the presenter, the comment, receiving input indicating selection of the comment, and displaying, through the user interface to the other party other than the presenter, a particular portion of the document and a particular portion of the presentation concurrently with the comment. Associating the comment with the document or the presentation may include associating the comment with the particular portion of the document or the particular portion of the presentation.

In general, in an aspect, a method includes presenting, through a user interface to a job applicant, a document that contains information about a job opening and a link for a video presentation in which a manager or co-worker associated with the job opening describe the job opening or an area in which the job opening is based, receiving selection of the link, and providing the video presentation to the job applicant through the user interface.

In general, in an aspect, a system includes a document database to store a document that contains information about an employment relationship of a person with an entity, a video database to receive video information capturing a video presentation about the information contained in the document, and a synchronization engine that synchronizes the video presentation with a document presentation of the information contained in the document.

Implementations of this aspect or another aspect may include one or more of the following features. The system may include a presentation engine that provides a synchronized presentation created by the synchronization engine to a user device.

These and other aspects, features, and implementations, and combinations of them, may be expressed as apparatus, methods, methods of doing business, means or steps for performing functions, components, systems, program products, and in other ways.

The subject matter described in this specification can be implemented in particular embodiments and may result in one or more of the following advantages. In some implementations, the use of social features and/or video features for talent management or human resources tasks may increase user engagement with those talent management or human resources tasks. In some implementations, the use of social features and/or video features for talent management or human resources tasks may provide better collaboration, e.g., by allowing an interview team to review video submitted by an candidate or to create discussion threads about candidate.

Other aspects, features, and advantages will be apparent from the description and the claims.

### DESCRIPTION

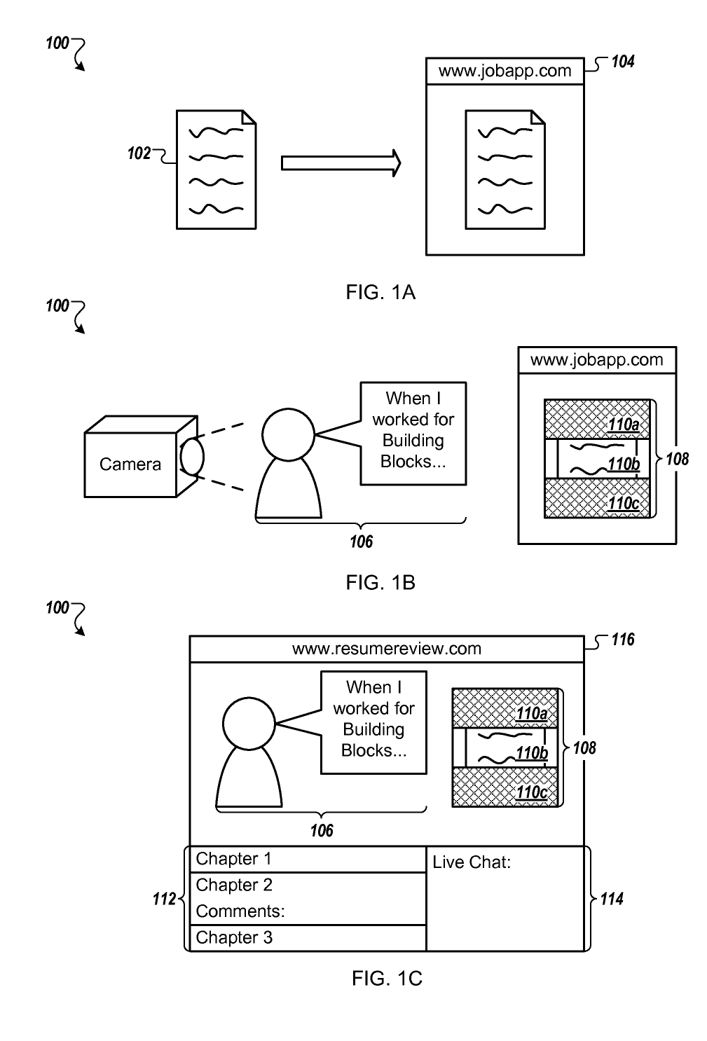

FIGS. 1A-C show an example of a talent management environment that provides users with social features and video features to increase user engagement and interest in talent management activities.

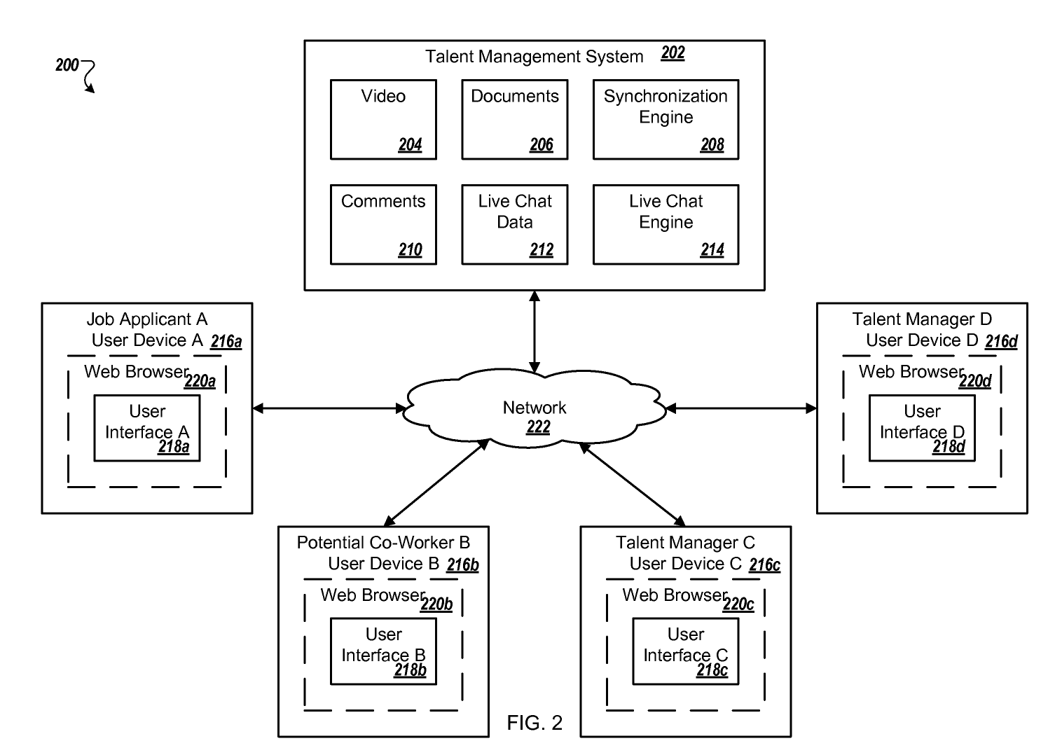

FIG. 2 shows a block diagram of an environment in which a talent management system synchronizes video with respective portions of a talent-management related document described or discussed in the video.

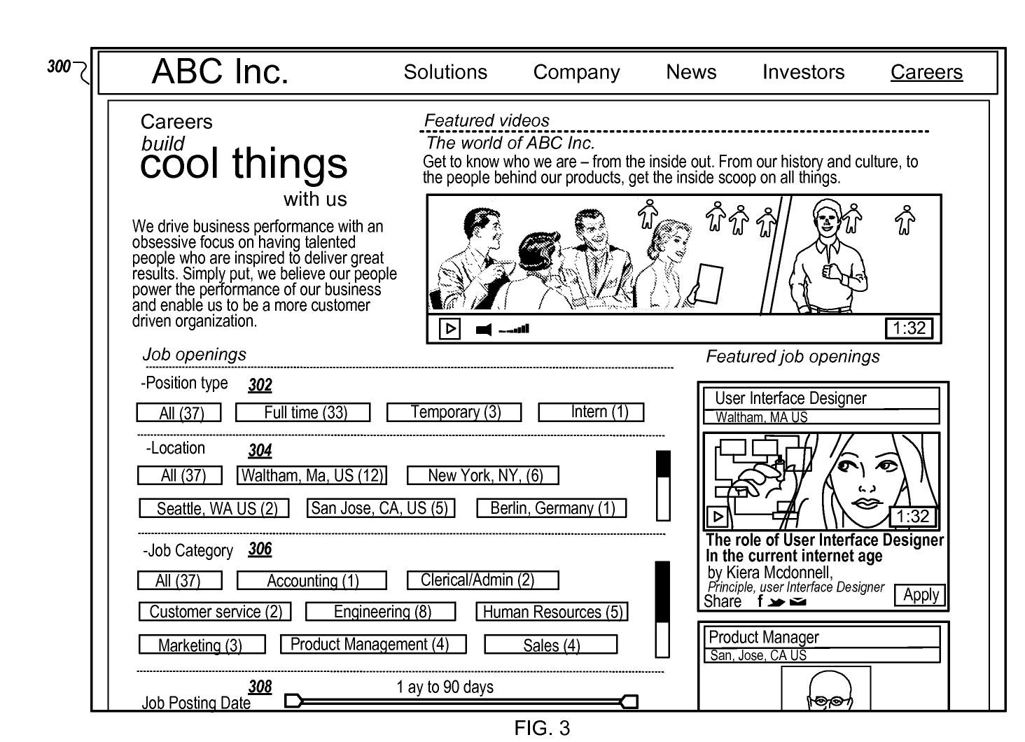

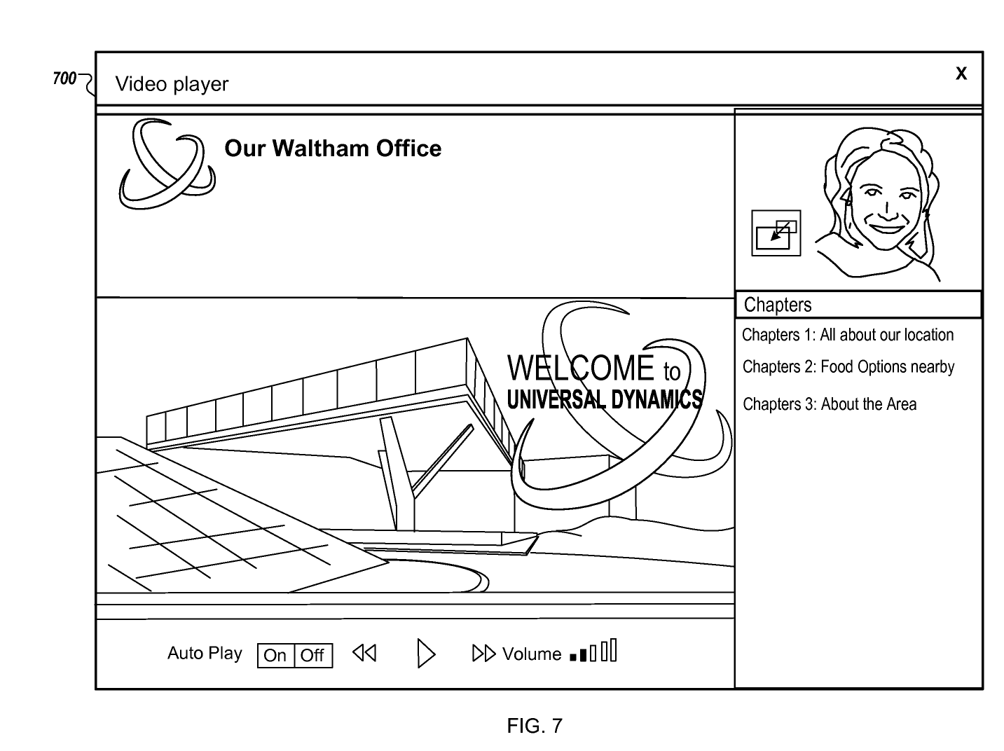

FIGS. 3-7 show examples of job openings user interfaces.

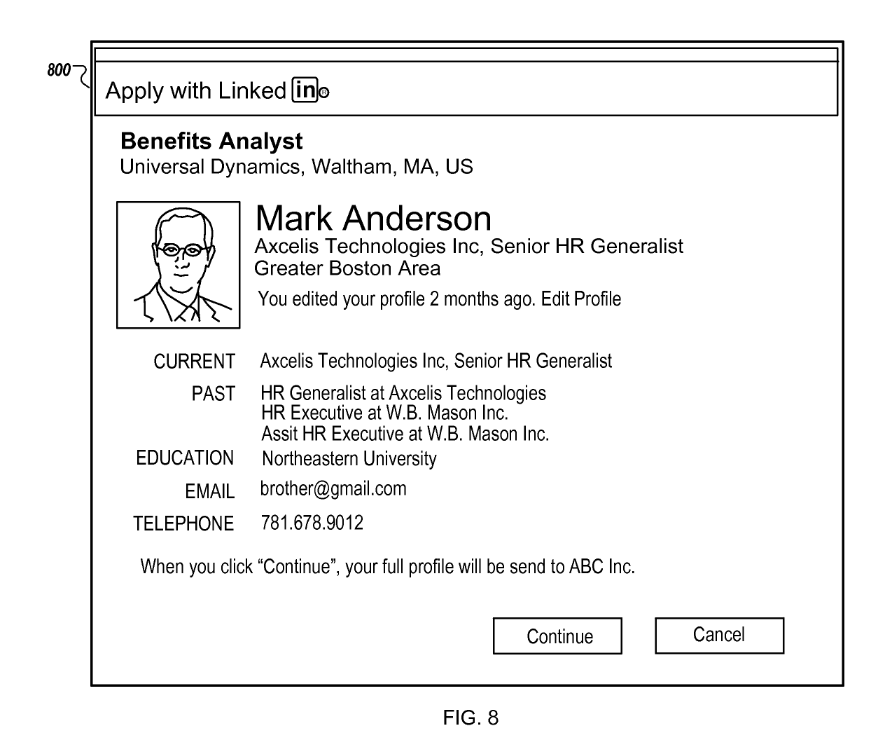

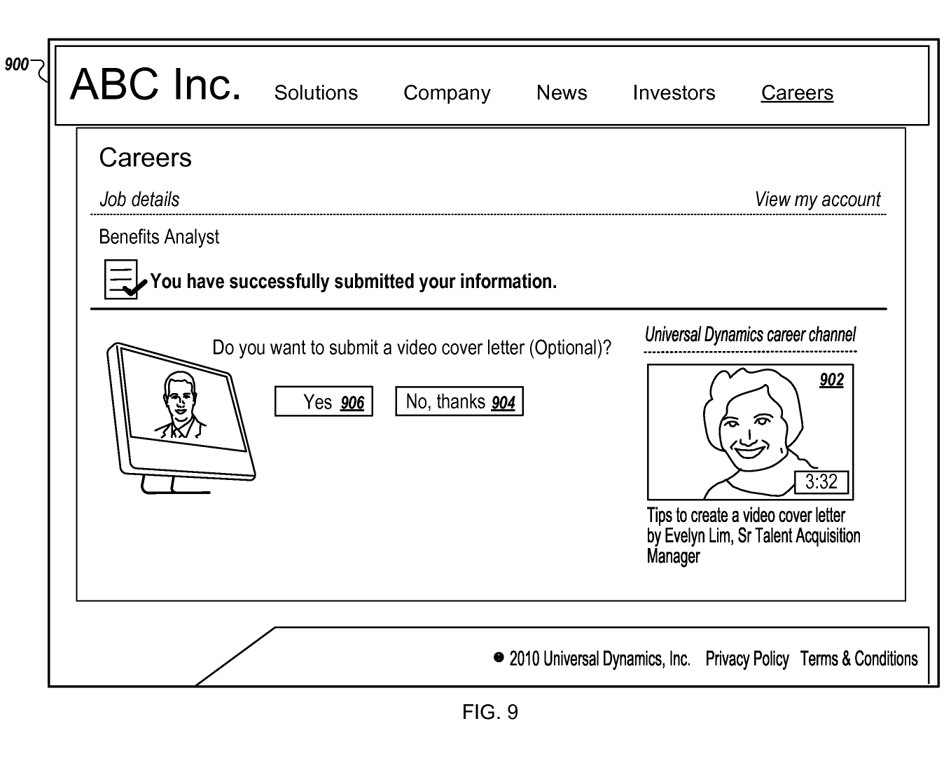

FIGS. 8 and 9 show examples of job applicant user interfaces.

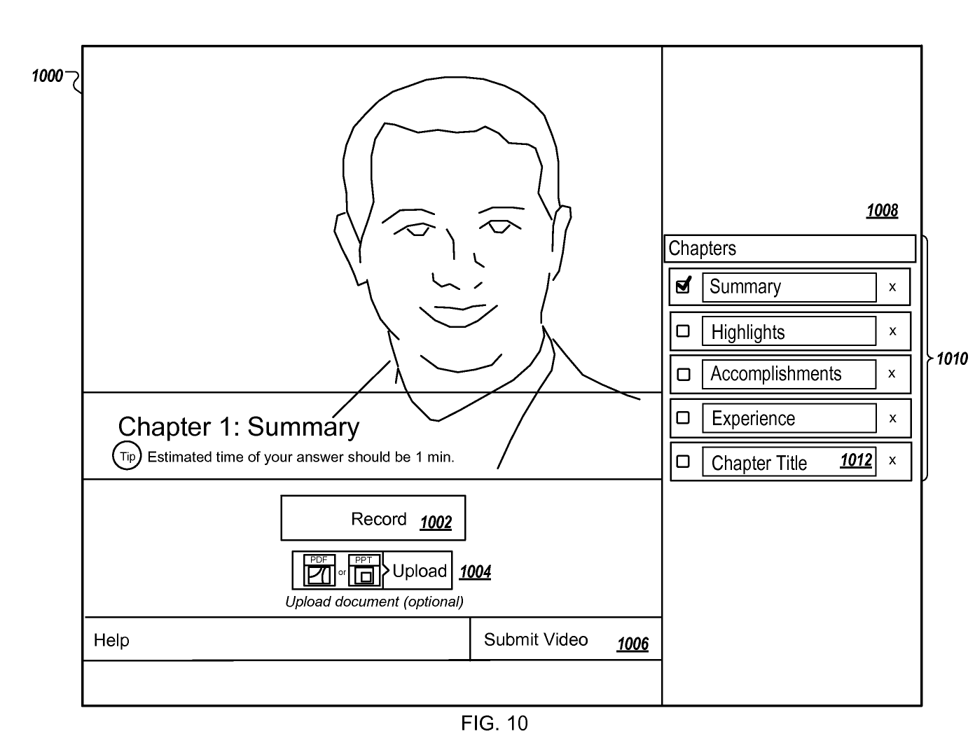

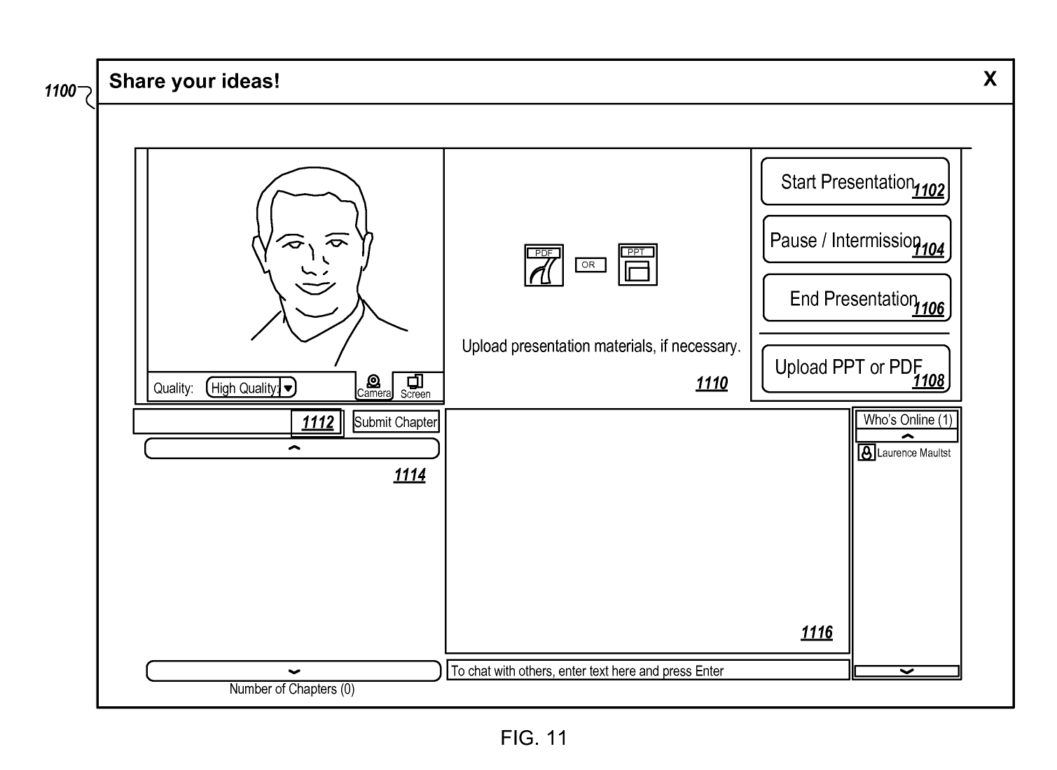

FIGS. 10 and 11 show examples of video submission user interfaces.

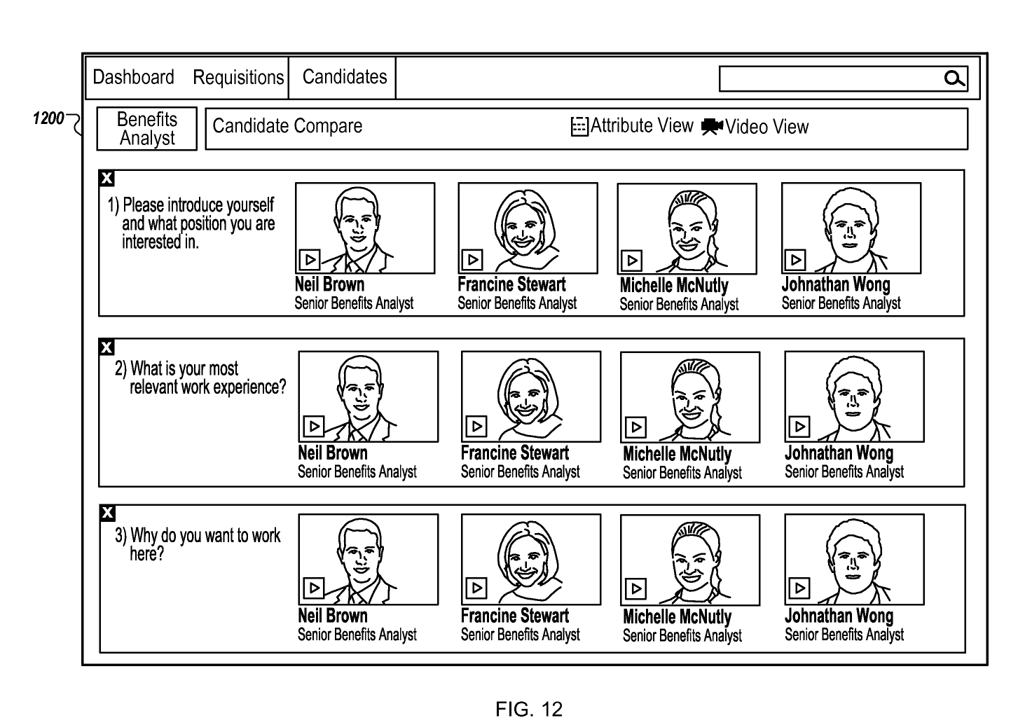

FIG. 12 is an example of a candidate comparison user interface.

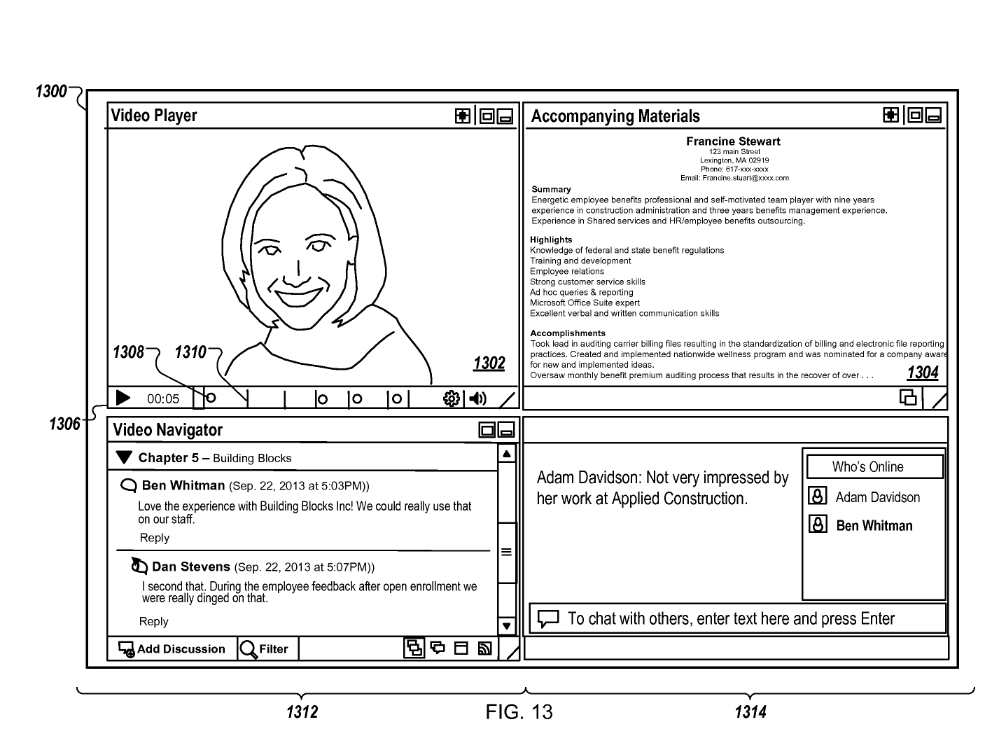

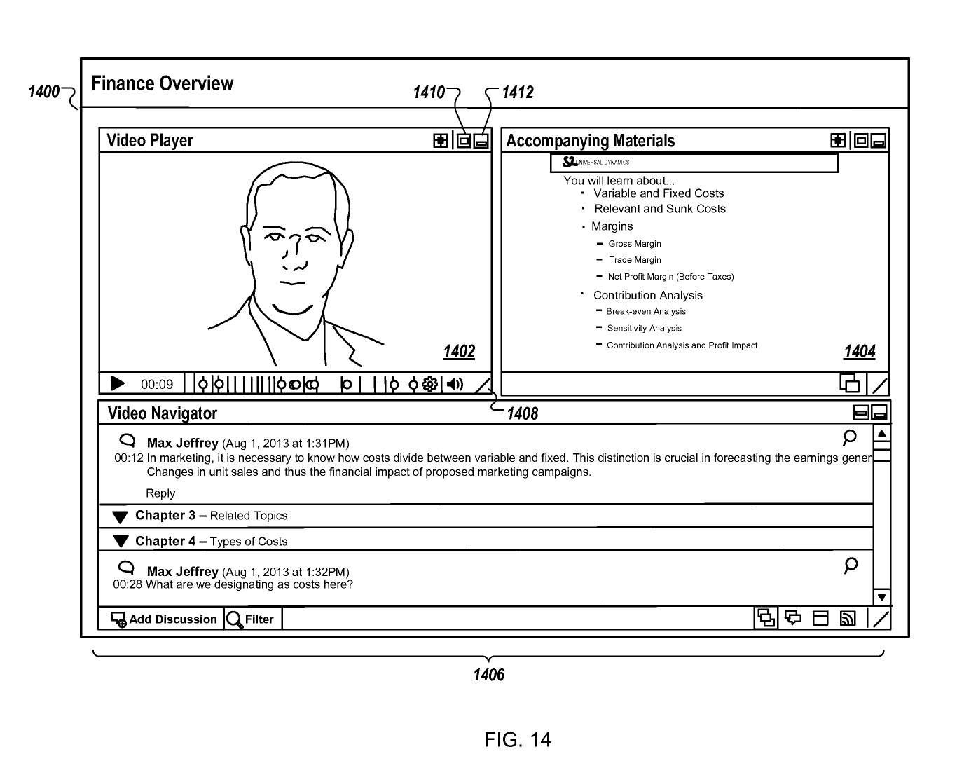

FIGS. 13 and 14 show examples of coordinated presentation user interfaces.

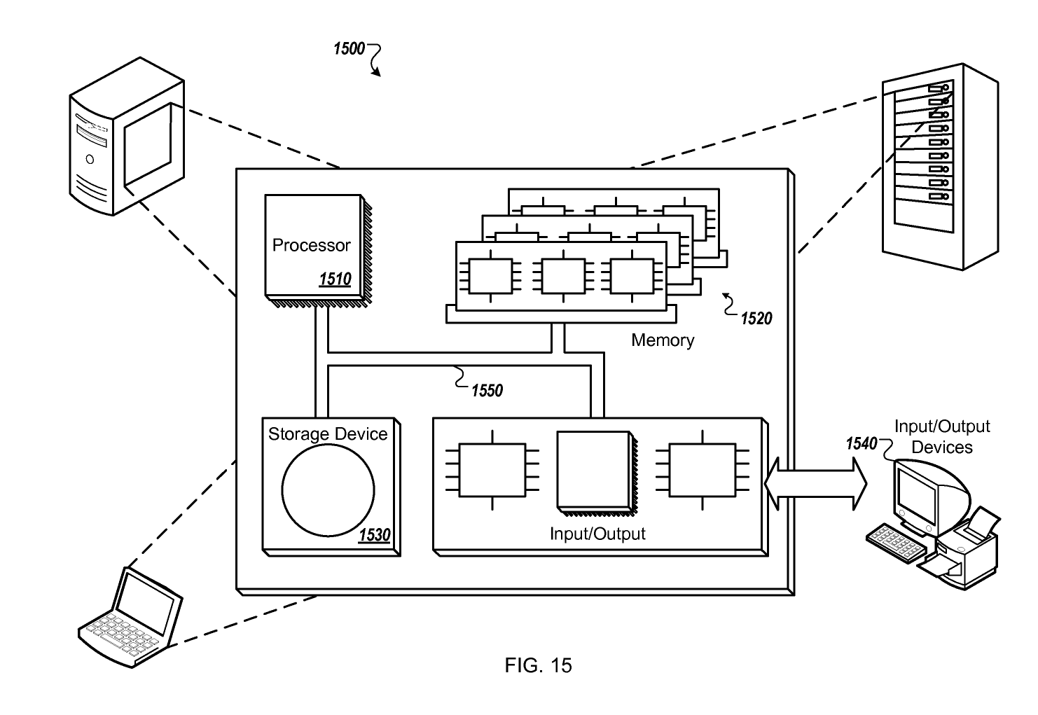

FIG. 15 is a block diagram of an example computer system.

FIGS. 1A-C show an example of a talent management environment 100 that provides users with social features and video features to increase user engagement and interest in talent management activities. We use the phrase talent management activities broadly to include, for example, recruiting, training, developing, reviewing, supervising, evaluating, compensating, succession planning, and managing from the point of view of an entity or person who is the target of the talent management activity or an entity or person who is a source of the talent management activity.

As an example of a talent management activity, after locating a possible job online, a job applicant may submit a copy of an electronic document (for example, a Microsoft Word file) containing her resume 102 as part of a job application process using a website 104, as shown in FIG. 1A. The job applicant then records a video 106 describing how items recited on her resume 108 are relevant to a position for which she is applying, as shown in FIG. 1B.

While she is recording the video, related portions of the resume can be displayed or identified (either automatically or by her) on the display. The talent management environment 100 can synchronize (that is, can track the timing within) the video 106 with portions 110a-c of the resume 108 that are being presented while different portions of the video 106 are being captured. Using the tracking information, the corresponding portions of the resume can be displayed in synchrony with the corresponding portions of the video during later playback of a coordinated presentation. In the example shown in FIG. 1A, the job applicant describes a previous company she worked for, “Building Blocks,” and the corresponding portion 110b of the resume 108 is highlighted in a user interface for the website 104. The talent management environment 100 also synchronizes corresponding portions of the video for a first portion 110a of the resume and a third portion 110c of the resume. The highlighting of a portion of the resume 108 may include presenting the portion in the website 104 or in some other way causing a viewer of the coordinated presentation to focus on the portion of the resume 108.

The job applicant, or an employee of the company at which the job applicant is applying for the position, or a variety of other people involved in the recruiting process, from either side, may view the coordinated presentation of the resume 108 including the video 106, as shown in FIG. 1C.

In some examples, the employee of the company may interact with social features, e.g., by adding comments 112 to a portion of the coordinated presentation or by chatting 114 with other employees who are viewing the same portion or a different portion of the coordinated presentation. For example, when a website 116 provides a particular chapter of the presentation, such as chapter two, to the employee, the talent management environment 100 associates any comments entered by the employee with that particular chapter of the presentation.

The talent management environment 100 may also include social and video features for talent management tasks other than recruiting. For instance, a talent manager may submit a business plan for an executive at a company and describe in a video presentation how that executive would be a good fit for another position at the company as part of a succession planning process.

FIG. 2 is an example block diagram of an environment 200 in which a talent management system 202 synchronizes video 204 with respective portions of a talent-management related document 206 described or discussed in the video 204. We use the term documents 206 broadly to include, for example, any kind of file or material that presents talent-management related information, such as a resume, a cover letter, a self-assessment, a goal, an employee evaluation, a photograph, a spreadsheet, or a business plan. Documents may be in any form including paper or electronic files of any file format.

As described with reference to FIG. 1, in some examples, the talent management system 202 may receive a document 206, such as a resume, from a user device A 216a operated by a job applicant A. The job applicant A may interact with a user interface A 218a included in an application, such as a web browser 220a, to upload the resume to the talent management system 202. In some examples, the job applicant A may use another application, such as a custom resume submission application, instead of the web browser 220a.

The user interface A 218a receives input from the job applicant A indicating that the user device A 216a should capture a video presentation of the job applicant A describing her resume. The user device A 216a stores video information of the video presentation in memory, e.g., on a disk drive.

The user device A 216a may receive a synchronization engine 208 from the talent management system 202, e.g., with instructions for the presentation of the user interface A 218a or as part of a custom resume submission application, that synchronizes the captured video presentation with a presentation of the document 206 in the user interface A 218a. Once the capture and synchronization of the video presentation, with the document presentation, are complete the user device A 216a provides the coordinated presentation to the talent management system 202, e.g., in response to job applicant selection of a submit coordinated presentation option on the user interface A 218a.

In some examples, the user device A 216a may provide video information representing a recording of the video presentation as a stream of content directly to the talent management system 202. While the talent management system 202 receives video information capturing the presentation by the job applicant A describing her resume, the synchronization engine 208, at the talent management system 202, synchronizes the captured video presentation with the portions of the resume presented in the user interface A 218a.

The synchronization of the captured video presentation with the portions of the resume allows the talent management system 202 to provide a coordinated presentation that includes the captured video presentation and the resume to another user interface C 218c, included on another user device C 216c, for instance, controlled by a talent manager C at an entity, e.g., a company, a business, or an organization. The other user interface C 218c may be included in a web browsers 220c or another application, e.g., that allows the talent manager C to view job applications and perform talent management or human resources tasks.

While the user interface C 218c presents the coordinated presentation to the talent manager C, another user interface D 218d may present the same coordinated presentation, e.g., the same or a different portion of the coordinated presentation, on another user device D 216d to another talent manager D. The user devices C-D 216c-d may submit comments 210 from their respective talent managers to the talent management system 202, which stores the comments 210 in memory and associates the comments with respective portions of the coordinated presentation, either the respective portion of the document 206, the video 204, or both. Upon receipt of a comment, the talent management system 202 ensures that all versions of the same coordinated presentation include the comment, e.g., by sending data representing the comment to the corresponding user devices 216c-d.

When the talent management system 202 receives identification of selection of one of the comments, the talent management system 202 may provide the corresponding portion of the coordinated presentation to the requesting user device that provided the identification to the talent management system 202. For instance, when the user device C 216c submits a comment about a second portion of a coordinated presentation to the talent management system 202 and the user device D 216d provides the talent management system 202 with identification of selection of the comment, the talent management system 202 may provide the user device D 216d with the second portion of the coordinated presentation for display on the user interface D 218d.

The environment 200 may allow a potential co-worker B of the job applicant A to view a portion of the document and/or a portion of the video submitted by the job applicant A, while maintaining the job applicant's privacy, and comment or chat about the job applicant A, e.g., and the job applicant's fit with the position for which they applied. The talent management system 202 includes a live chat engine 214 that allows the potential co-worker B to chat with another employee at the entity, such as the talent manager C. The talent management system 202 may store live chat data 212 from the live chat engine 214 in memory. For example, the user interface B 218b may include an option to associate the live chat data 212 with a respective portion of the coordinated presentation provided on the user interface B 218b while the potential co-worker B communicated with the talent manager C. The live chat engine 214 may receive selection of the option and store the live chat data 212 in a memory of the talent management system 202. In some examples, the talent management system 202 does not store the live chat data 212 in a permanent, e.g., non-volatile, memory.

The talent management system 202 allows the potential co-worker B and the talent managers to submit videos that provide a job applicant A with information about a position for which the job applicant A may apply. For instance, a talent manager or a potential co-worker may describe the position, such as the duties assigned to the position, the entity providing the position, an area in which the position is based, such as a city or a state, or a combination of things which may help the job applicant A determine whether or not to apply for the position.

In some implementations, the talent management system 202 includes a presentation engine, e.g., as part of the synchronization engine 208 or another part of the talent management system 202. The presentation engine receives a coordinated presentation from the synchronization engine 208, or a memory in the talent management system 202, and provides the coordinated presentation to one of the user devices 216a-d, e.g., in response to a request for the coordinated presentation.

The user devices 216a-d may include personal computers, mobile communication devices, scanners, and other devices that can send and receive data over a network 222. The network 222, such as a local area network (LAN), wide area network (WAN), the Internet, or a combination thereof, connects the user devices 216a-d and the talent management system 202, e.g., one or more servers that perform the operations of the talent management system 202 and store the data of the talent management system 202 in memory.

FIG. 3 is an example of a job openings user interface 300. The job openings user interface 300 allows a user to search for job openings based on position type 302, location 304, and/or job category 306. The user may filter the job openings based on a date the position was posted 308 or an end date for the job opening.

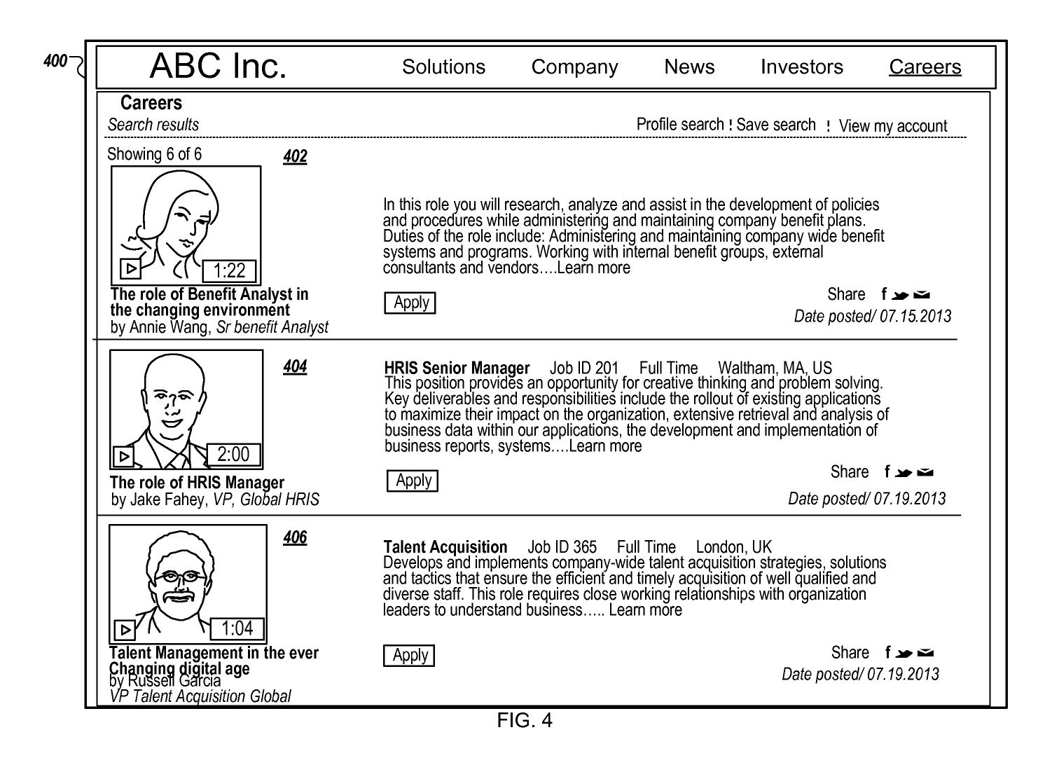

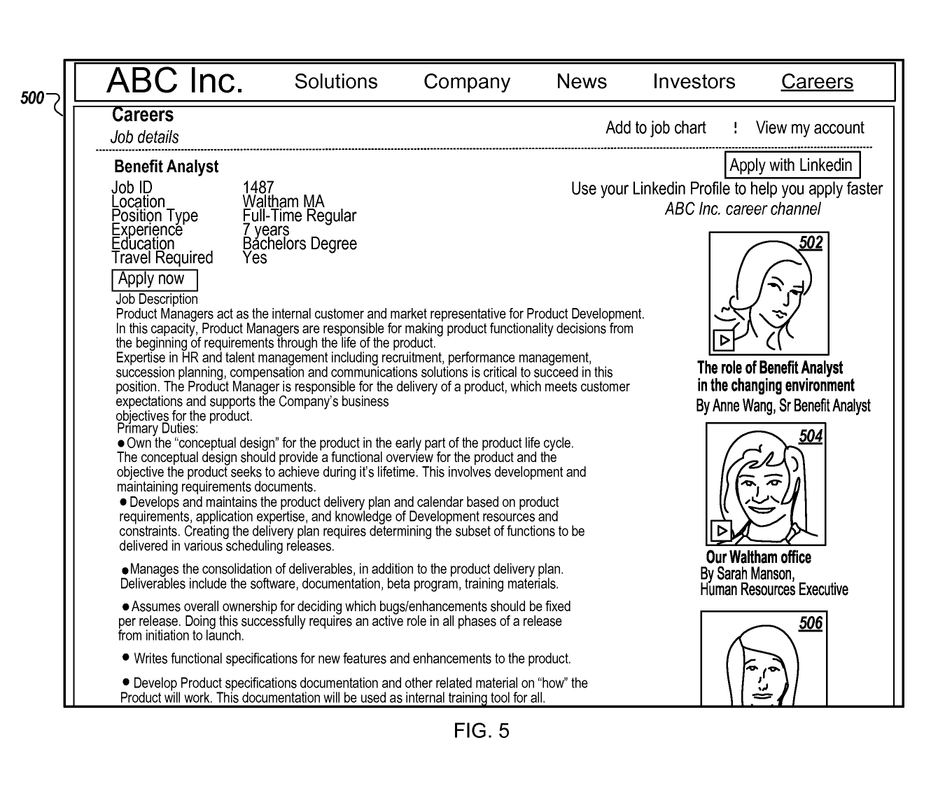

Selection of one or more of the filtering options in the job openings user interface 300 may cause the presentation of a search results user interface 400, shown in FIG. 4. The search results user interface 400 includes a first 402, a second 404, and a third 406 search result with short descriptions about each of the corresponding positions and links to view additional information about the positions and apply for the positions. The search results user interface 400 may include links to videos that provide additional information about the corresponding job opening, as described in more detail with reference to FIG. 5.

When a talent management system receives an indication of a selection of the first search result 402 from a user device, the talent management system may provide the user device with instructions to present a job description user interface 500, shown in FIG. 5. The job description user interface 500 includes one or more videos that provide a job applicant with information about the position.

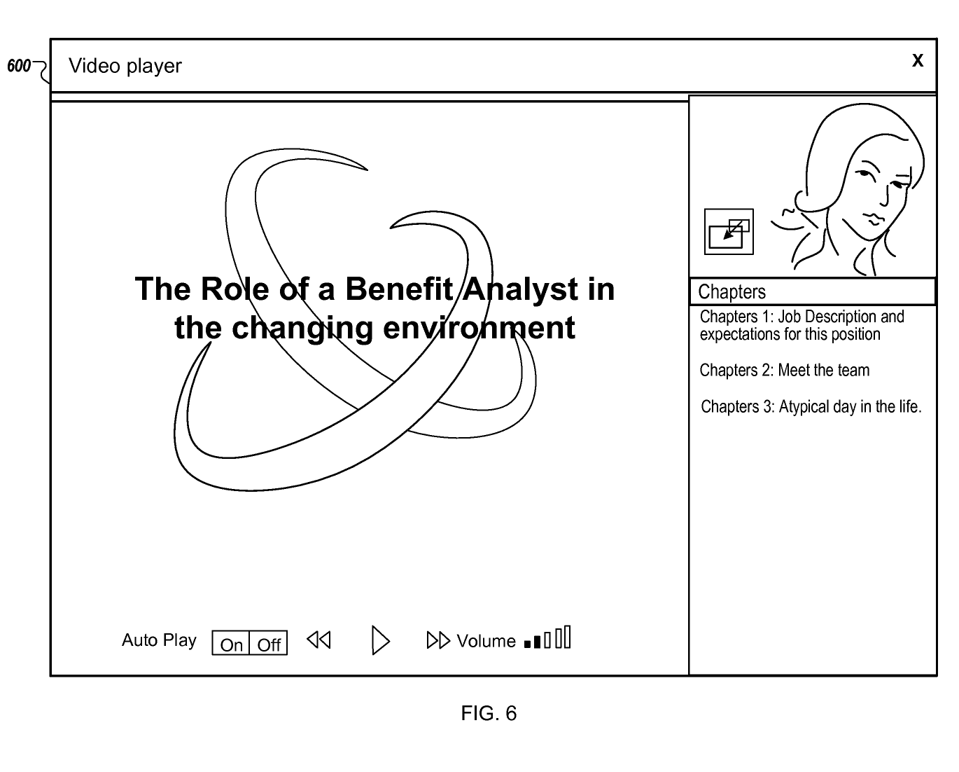

For instance, selection of a job description video link 502 may present a job description video 600, shown in FIG. 6, that includes a co-worker describing certain aspects of the position. The job description video 600 may be a coordinated presentation, with particular portions of the job description highlighted or otherwise indicated in the job description user interface 500 when the job description video 600 provides information about those portions of the job description. For instance, when the entire job description is not presented on a display screen at the same time, the presentation of the job description may automatically scroll to provide a job applicant with reference to which portions of the job description are currently being described in the job description video. In some examples, the job description video 600 is presented separate from the job description in the job description user interface 500, e.g., the job description video may overlay some of or the entire job description user interface 500.

Selection of an office description link 504 causes the presentation of an office description video 700 that describes the office in which the job would be located, such as the work environment, and the area around the office, including restaurants, places of interest, and weather, among other aspects of the office. Selection of an entity description link 506 causes the presentation of an entity video that provides information about the entity, such as the entity's history, values, or mission statement to name a few examples. Any of the videos may be presented concurrently with at least a portion of the job description user interface 500 and/or may be coordinated presentations. Any of videos may also include chapters to allow a person to jump to a specific portion of the video, e.g., if they want to view that portion again.

The videos may provide a job applicant with more information about a position than the job description alone. For instance, the job applicant may engage with the videos more than just the job description and may be able to see some of their potential co-workers, such as a manager or someone who has the same position or title as the position for which the job applicant is applying, prior to attending an interview.

FIG. 8 is an example of an applicant profile user interface 800. The applicant profile user interface 800 allows a job applicant to enter work history information and contact information. The job applicant may enter the profile information using the applicant profile user interface 800 after viewing the job description user interface 500 and, optionally, one or more videos with information about the position, the entity, or the area in which the position is located.

The job application process may include additional user interfaces, such as a video cover letter user interface 900, shown in FIG. 9. The video cover letter user interface 900 provides a job applicant with a link for a video 902 with instructions on preparing a video cover letter and/or submitting a video as part of a job application process.

If the job applicant indicates that they do not want to submit a video cover letter or a video as part of the application process by selecting a “no” option 904, the talent management system may submit the information from the user's profile and any other information provided by the applicant, e.g., a resume, to an entity for which the position was offered. In some examples, the job applicant may be presented with an option to upload a video, e.g., that captures the job applicant answering questions about themselves, as part of the application process without a cover letter.

Upon selection of a “yes” option 906, a video submission user interface 1000, shown in FIG. 10, is presented to the job applicant. The video submission user interface 1000 includes an upload document option 1004. Once a document is uploaded to the talent management system, an image 1008 of the document is presented in the video submission user interface 1000.

The job applicant may select a record option 1002 to initiate a capture of a presentation by the job applicant describing the uploaded document, e.g., resume or video cover letter. The job applicant may change the portion of document represented by the image 1008 during the capture of the video presentation, e.g., by scrolling through the document, and the talent management system or a device controlled by the job applicant may synchronize the presentation of the document with the video presentation by the job applicant.

After selection of the record option 1002, the video submission user interface 1000 presents a stop option that, upon selection, stops the recording of the video presentation. The job applicant may then submit the video presentation with selection of a submit video option 1006. In some examples, selection of the submit video option 1006 may provide a talent management system with other files in addition to a coordinated presentation. For instance, the talent management system may receive a copy of the job applicant's resume and any other files or data the job applicant provided during a job application process.

Prior to submission, the job applicant may synchronize the presentation of the video with the presentation of the image 1008 of the document, e.g., if the talent management system or the device controlled by the job applicant does not automatically perform the synchronization or to supplement a synchronization. For example, the job applicant may create chapters 1010 for the video presentation, using a create chapter option 1012, and indicate which portions of the document should be presented for each of the chapters 1010. The user device controlled by the job applicant and/or the talent management system may use any appropriate method to synchronize the video presentation with the document presentation.

The job applicant may view the coordinated presentation that includes both the video presentation and the document presentation prior to submission, e.g., before the device controlled by the job applicant provides the talent management system with the coordinated presentation or, when the talent management system receives a video stream from the job applicant's device, before the job applicant finalizes the application process. The video submission user interface 1000 may include an option for the job applicant to initiate a new recording of the video presentation, create multiple separate video presentations for different portions of the document and/or different chapters, or remove a portion of the video presentation, in addition to submitting the coordinated presentation to the talent management system with selection of the submit video option 1006.

FIG. 11 is an example of another video submission user interface 1100. An upload document option 1108 allows a user to select a document, such as a presentation document, to upload to the talent management system. In the example shown in FIG. 11, an employee of an entity may upload a self-evaluation or one or more goals, e.g., career development goals.

The employee may initiate a capture of a presentation describing the uploaded document with a start presentation option 1102, and may pause or end the capture with a pause option 1104 and an end option 1106, respectively. As with the video submission user interface 1000, the employee may change the content of the document presented in a preview window 1110 during the presentation and the talent management system, or a device controlled by the employee, may synchronize the video presentation with the document presentation.

The video submission user interface 1100 includes a create chapter option 1112 which adds a new chapter to a chapter list 1114 for the video presentation. During later playback of a coordinated presentation, created from the video presentation and the document presentation, a user may select one of the chapters to jump to a corresponding location in the video presentation and document presentation.

A chat interface 1116 may allow the employee to initiate conversation with another user. For instance, when the employee submits a self-evaluation or a goal, e.g., as part of an evaluation process, the employee may initiate a conversation with their manager to discuss a question, e.g., about the evaluation process or the employee's self-evaluation or goal.

The video submission user interface 1000 or the other video submission user interface 1100 may be used for other processes in addition to or instead of a job application processes, self-assessments, and goal submission or review. For instance, a manager may submit a video, and optionally a corresponding document, as part of an employee evaluation. Another manager may view the employee evaluation video, as described in more detail below. A person may also submit a video and/or a document as part of a business plan. The submission of a video as part of a job application process, or another talent management or human resources process, may help a talent manager or another person at an entity get to know the person in the video presentation better, e.g., prior to an interview, and create more interest in the submitted documents. The coordinated video presentation may also help convey information that is not easily written in a document, e.g., such as someone's personality type. Some additional examples of corresponding documents may include work samples, a questionnaire, or response to a questionnaire.

FIG. 12 is an example of a candidate comparison user interface 1200. As part of an application process, for a new employee or a transfer between positions at an entity, job applicants may be asked to answer questions, such as: 1) “Please introduce yourself and what position you are interested in.”, 2) “What is your most relevant work experience?”, and 3) “Why do you want to work here?” The job applicants may submit video responses to the questions, e.g., using the video submission user interface 1000 or the video submission user interface 1100 that present the corresponding question instead of a portion of a document. In this example, selection of a submit video option may cause the presentation of the next question in the user interface until the job applicant has answered all of the questions.

A talent manager may view the video presentations in a coordinated presentation user interface 1300, shown in FIG. 13, to select one of the job applicants for the position. The coordinated presentation user interface 1300 may present a video presentation 1302 and a document preview 1304. The document preview 1304 may include questions, e.g., from the candidate comparison user interface 1200, or a document submitted by the job applicant, such as a resume. The content presented in the document preview 1304 may change during the coordinated presentation, e.g., based on the currently presented portion of the video presentation 1302 and/or chapter of the coordinated presentation.

The coordinated presentation user interface 1300 includes a video navigation bar 1306 which allows a person to cause the display of different portions of the video presentation 1302. The video navigation bar 1306 includes comment identifiers 1308 and chapter identifiers 1310 that indicate the time at which a person created a comment, e.g., in a chapter panel 1312, and the start and stop times for the chapters. The video navigation bar 1306 may include a forward option and a backward option that cause the coordinated presentation to change to the time associated with the next comment, or chapter. In some examples, the forward option and backward option may move the presentation between either comments or chapters, but not both.

A person may enter a comment in response to a statement made by the job applicant or a corresponding portion of the document in the document preview 1304. The chapter panel 1312 may allow people to reply to comments, edit comments, delete comments, or create new comments. The chapters in the chapter panel 1312 may correspond with different positions at which the job candidate worked, different entities for which the job candidate worked, and/or portions of a resume. For example, some chapter names may include “Summary,” “Building Blocks Inc.,” “Construction Company HR,” and “Applied Construction” indicating companies for which the job applicant worked. In some examples, the chapters may correspond with goals, steps in a business plan, or employee achievements.

The coordinated presentation user interface 1300 also includes a live chat option 1314 that allows people who are viewing the same coordinated presentation, e.g., the same portion of the presentation or different portions, to discuss the job candidate. The live chat option 1314 may allow a person to send another person a link to a specific portion of the video presentation 1302 which the person is viewing, e.g., to allow both people to discuss the specific portion of the video presentation 1302.

In some examples, the live chat option 1314 may allow people viewing different coordinated presentations, or who are both using a chat interface, to interact. For instance, a user device presenting the coordinated presentation user interface 1300 may send a link for a particular coordinated presentation to another user device presenting a chat interface, i.e., but not the coordinated presentation user interface 1300. Selection of the link on the other user device may cause an application to present the coordinated presentation user interface 1300 on the other user device and the presentation of the particular coordinated presentation.

FIG. 14 is another example of a coordinated presentation user interface 1400. The coordinated presentation user interface 1400 includes a video presentation 1402, a document preview 1404, and a chapter panel 1406 with comments. A person may interact with the coordinated presentation user interface 1400 to move or adjust the size of any of the elements included in the coordinated presentation user interface 1400, e.g., the video presentation 1402, the document preview 1404, and/or the chapter panel 1406. For instance, each element may include a maximize option 1408, a minimize option 1410, and a resize option 1412. Similarly, a person may interact with the coordinated presentation user interface 1300 to adjust the size and/or position of any of the elements in the coordinated presentation user interface 1300, e.g., the video presentation 1302, the document preview 1304, the chapter panel 1312, and/or the live chat option 1314.

FIG. 15 is a block diagram of an example computer system 1500. For example, referring to FIG. 2, the talent management system 202 or a server forming a portion of the talent management system 202 could be an example of the system 1500 described here, as could a computer system used by any of the users who access resources of the talent management system 202, e.g., the user devices 216a-d. The system 1500 includes a processor 1510, a memory 1520, a storage device 1530, and an input/output device 1540. Each of the components 1510, 1520, 1530, and 1540 can be interconnected, for example, using a system bus 1550. The processor 1510 is capable of processing instructions for execution within the system 1500. In some implementations, the processor 1510 is a single-threaded processor. In some implementations, the processor 1510 is a multi-threaded processor. In some implementations, the processor 1510 is a quantum computer. The processor 1510 is capable of processing instructions stored in the memory 1520 or on the storage device 1530. The processor 1510 may execute operations such as coordinating a video presentation with a document presentation (FIG. 1).

The memory 1520 stores information within the system 1500. In some implementations, the memory 1520 is a computer-readable medium. In some implementations, the memory 1520 is a volatile memory unit. In some implementations, the memory 1520 is a non-volatile memory unit.

The storage device 1530 is capable of providing mass storage for the system 1500. In some implementations, the storage device 1530 is a computer-readable medium. In various different implementations, the storage device 1530 can include, for example, a hard disk device, an optical disk device, a solid-date drive, a flash drive, magnetic tape, or some other large capacity storage device. In some implementations, the storage device 1530 may be a cloud storage device, e.g., a logical storage device including multiple physical storage devices distributed on a network and accessed using a network. In some examples, the storage device may store long-term data, such as the video 204 and documents 206, as well as the comments 210 and the live chat data 212. The input/output device 1540 provides input/output operations for the system 1500. In some implementations, the input/output device 1540 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. A network interface device allows the system 1500 to communicate, for example, transmit and receive data such as the video 204 and the documents 206 shown in FIG. 2. In some implementations, the input/output device can include driver devices configured to receive input data and send output data to other input/output devices, e.g., keyboard, printer and display devices 1560. In some implementations, mobile computing devices, mobile communication devices, and other devices can be used.

A server (e.g., a server forming a portion of the talent management system 202 shown in FIG. 2) can be realized by instructions that upon execution cause one or more processing devices to carry out the processes and functions described above, for example, sending and receiving the live chat data 212 and coordinating video and document presentations (FIG. 2). Such instructions can include, for example, interpreted instructions such as script instructions, or executable code, or other instructions stored in a computer readable medium. A talent management system 202 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 15, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for creating and maintaining coordinated presentations (FIGS. 1 and 2), can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of a talent management system 202) is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A method comprising:
presenting, through a user interface, a document that contains information about an employment relationship of a person with an entity,
while the document is being presented through the user interface, receiving from a presenter video information capturing a presentation about the information contained in the document, and
providing a coordinated presentation of the document and the presentation to the presenter or to a party other than the presenter, through a user interface.

2. The method of claim 1 comprising:
receiving the document from a user device controlled by the presenter.

3. The method of claim 2 in which the document comprises information about a job position.

4. The method of claim 3 in which the presenter is a talent manager and the presentation comprises the talent manager describing a performance of the person while executing duties for the entity.

5. The method of claim 1 comprising:
determining, for each portion of the presentation, which corresponding portion of the document is displayed in the user interface when the respective portion of the presentation is captured, and
providing the corresponding portions of the document concurrently with the respective portions of the presentation.

6. The method of claim 1 in which the document comprises a resume, a cover letter, a self-assessment, a goal, an employee evaluation, a business plan, a question for a job applicant, or any combination of two or more of them.

7. The method of claim 1 in which the presenter is a job applicant for a position administered by the party other than the presenter, the method comprising:
presenting, to the job applicant prior to presenting the document, video information of the party other than the presenter describing the position.

8. The method of claim 1 in which the presenter is a job applicant for a position at an entity with which a potential co-worker is associated, the method comprising:
presenting, to the job applicant prior to presenting the document, video information of the potential co-worker describing the position, the entity with which the potential co-worker is associated, or an area in which the position is based.

9. The method of claim 1 comprising:
receiving a comment about the information about the document or the presentation while providing the coordinated presentation of the document and the presentation, and
associating the comment with the document or the presentation.

10. The method of claim 9 comprising:
presenting, through a user interface to another party other than the presenter, the document and the presentation concurrently with the comment.

11. The method of claim 10 in which presenting to the presenter or the party other than the presenter and the other party other than the presenter occur at substantially the same time.

12. The method of claim 9 comprising:
displaying, through a user interface to another party other than the presenter, the comment,
receiving input indicating selection of the comment, and
displaying, through the user interface to the other party other than the presenter, a particular portion of the document and a particular portion of the presentation concurrently with the comment.

13. The method of claim 12 in which associating the comment with the document or the presentation comprises associating the comment with the particular portion of the document or the particular portion of the presentation.

14. A method comprising:
presenting, through a user interface to a job applicant, a document that contains information about a job opening and a link for a video presentation in which a manager or co-worker associated with the job opening describe the job opening or an area in which the job opening is based,
receiving selection of the link, and
providing the video presentation to the job applicant through the user interface.

15. A system comprising:
a document database to store a document that contains information about an employment relationship of a person with an entity,
a video database to receive video information capturing a video presentation about the information contained in the document, and
a synchronization engine that synchronizes the video presentation with a document presentation of the information contained in the document.

16. The system of claim 15 comprising:
a presentation engine that provides a synchronized presentation created by the synchronization engine to a user device.
